(19) United States
(12) Patent Application Publication
(10) Pub. No.: US 2025/0331683 A1
(43) Pub. Date: Oct. 30, 2025

(54) BLENDER EXCITATION DEVICE IN BLENDER CONTAINER

(71) Applicant: Midea Group Co., Ltd., Foshan (CN)

(72) Inventors: Ryan Persaud, Louisville, KY (US); Matthew Hunter, Louisville, KY (US)

(73) Assignee: Midea Group Co., Ltd., Foshan (CN)

(21) Appl. No.: 18/644,967

(22) Filed: Apr. 24, 2024

(51) Int. Cl. A47J 43/08; A47J 43/046; A47J 43/07

(52) U.S. Cl. CPC A47J 43/085; A47J 43/0465; A47J 43/0722

(57) ABSTRACT

A blending appliance for blending liquid artifacts coupled with an excitation transducer. The excitation transducer produces vibrations that dislodge the liquid artifacts from the surface of the blender container assisting in cleaning and pouring. The blending container is coupled with a power source. When the blending container is removed from the housing base the power source provides power to the excitation transducer. The power source is a magnetic power source that electromagnetically transfers power from a coil in the housing base to the coil the blending container when the blending container is docked on the housing base.

### BACKGROUND

This disclosure relates in general to household electrical appliances and, not by way of limitation, to provisioning crushed food materials, among other things.

Blenders, mixers and food processors have long been utilized in domestic and commercial settings for various culinary purposes. Traditional blenders typically consist of a base housing containing a motor, a removable blending vessel, and a lid with an integrated blade assembly. These conventional blenders often suffer from limitations in terms of efficiency, ease of cleaning, and versatility in blending different types of ingredients.

Existing blender designs encounters issues such as inadequate blending performance, difficulty in disassembly for cleaning, and lack of adaptability to varying ingredient consistencies. Furthermore, conventional blenders may not provide sufficient control over blending speeds and may not offer specialized features for specific blending tasks.

### SUMMARY

In one embodiment, the present disclosure provides a blending appliance for blending liquid artifacts coupled with an excitation transducer. The excitation transducer produces vibrations that dislodge the liquid artifacts from the surface of the blender container assisting in cleaning and pouring. The blending container is coupled with a power source. When the blending container is removed from the housing base the power source provides power to the excitation transducer. The power source is a magnetic power source that electromagnetically transfers power from a coil in the housing base to the coil the blending container when the blending container is docked on the housing base.

In an embodiment, a blending appliance for blending liquid artifacts. The blending appliance comprises a housing base comprising a mixing motor to rotate a blade in contact with a liquid artifact during normal operation of the blending appliance. The blending appliance comprises a blending container removably coupled with the housing base to couple the mixing motor to the blade. The blending container comprises an excitation transducer to induce liquefaction in the liquid artifact proximate to interior surfaces of the blending container and a power source. The power source powers the excitation transducer to agitate liquids proximate to the interior surfaces of the blending container while the blending container is detached from the housing base.

In another embodiment, a method for a blending appliance for blending liquid artifacts. The blending appliance is configured to drive a mixing motor to rotate a blade in contact with a liquid artifact during normal operation of the blending appliance. The blending appliance powers an excitation transducer coupled to a blending container removably coupled with the housing base of the blending appliance. The blending appliance induces liquefaction in the liquid artifact proximate to interior surfaces of the blending container while the blending container is detached from the housing base.

In yet another embodiment, a blending appliance for blending liquid artifacts. The blending appliance comprises a housing base comprising a mixing motor to rotate a blade in contact with a liquid artifact during normal operation of the blending appliance. The blending appliance comprises a blending container removably coupled with the housing base to couple the mixing motor to the blade. The blending container comprises an excitation transducer to induce liquefaction in the liquid artifact proximate to interior surfaces of the blending container and a magnetic power source. The magnetic power source powers the excitation transducer to agitate liquids proximate to the interior surfaces of the blending container while the blending container is detached from the housing base.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 illustrates a block diagram of an embodiment of an excitation transducer in a blending appliance;

FIG. 2 illustrates a front profile of an embodiment of the blending appliance with a power cord that uses a magnetic field to connect;

FIG. 3 illustrates a diagram of an embodiment of the blending appliance vibrating during the pouring of liquid artifacts;

FIG. 4 illustrates a block diagram of an embodiment of an excitation device that uses an eccentric rotating mass (ERM) vibration motor to create vibrations;

FIG. 5 illustrates a block diagram of an embodiment of an excitation device that uses a transducer to create vibrations;

FIG. 6 illustrates a flowchart of a process of automatic activation of the excitation transducer in response to a back-electromotive force (EMF) sensor; and

FIG. 7 illustrates a flowchart of a process of activation of the excitation transducer in response to the back EMF sensor.

In the appended figures, similar components and/or features may have the same reference label. Further, various components of the same type may be distinguished by following the reference label by a dash and a second label that distinguishes among the similar components. If only the first reference label is used in the specification n, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

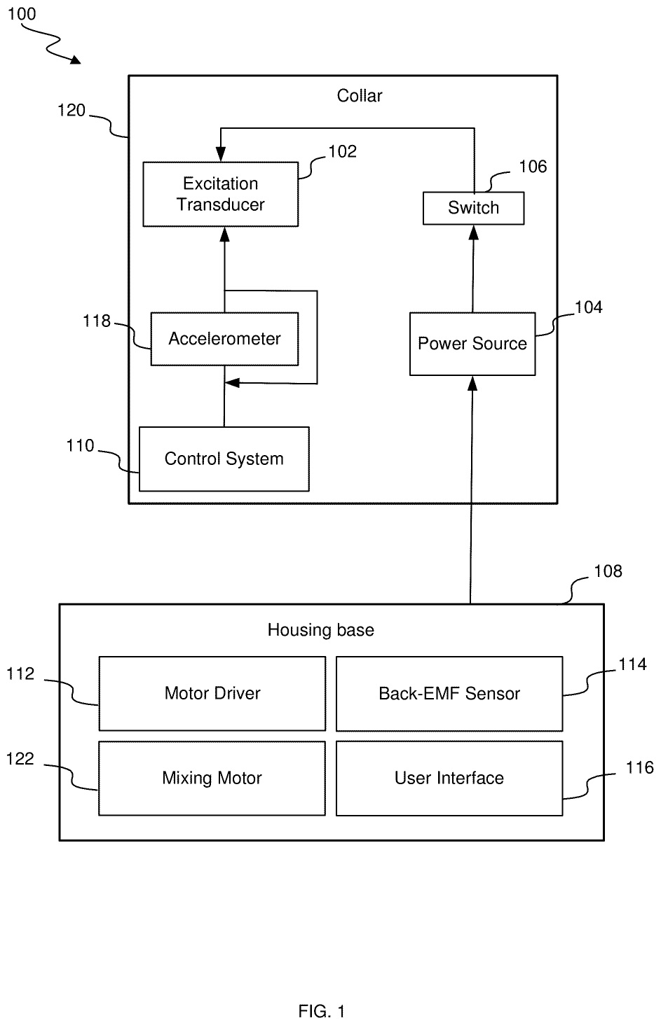

Referring to FIG. 1, illustrating a block diagram of an embodiment of an excitation transducer 102 in a blending appliance. System 100 includes a collar 120 and a housing base 108. The collar 120 includes the excitation transducer 102, a power source 104, a switch 106, a control system 110 and an accelerometer 118. The housing base 108 includes a back-electromotive force (EMF) sensor 114, a user interface 116, a motor driver 112 and a mixing motor 122. The blending appliance, which is a well-known appliance including a container with a removable lid and a motor-driven blade at bottom of a container for blending and preparing beverages. The operation of the blending appliance is not restricted to blending liquid artifacts but can be used for usual household operations. Here, the “blending appliance,” “blender,” “appliance,” “mixer,” etc. are used interchangeably.

In one embodiment, the collar 120 is located at the bottom of the container and connects the container to the housing base 108. The excitation transducer 102 that is an electronic device capable of producing vibration for example, ultrasonic transducers, eccentric rotating mass (ERM) vibration motors, piezoelectric transducers, magnetostrictive transducer etc. the excitation transducer 102 can be in any location if it is in direct contact with the container to transfer the vibrations better. The excitation transducer 102 can be positioned in a lid or in the handle of the container. In one embodiment, the excitation transducer 102 is sealed in the protective compartment and is detachable. A user can attach the compartment at any place on the container and detach it after use for washing purposes.

The power source 104 provides current to the excitation transducer 102 when the blending container is removed from the housing base 108. Examples of the power source 104 may include rechargeable batteries, capacitors, power cable, and inductive power receiver, etc.

The switch 106 is located anywhere on the container or the collar 120 that is accessible for the user. The switch 106 activates and deactivates the excitation transducer 102. The control system 110 determines the magnitude of the vibrations and regulates the operation of the excitation transducer 102. The accelerometer 118 is connected in the feedback loop to regulate a frequency of the vibrations of the excitation transducer 102.

The housing base 108 contains the machinery for function of the blender including the mixing motor 122 that rotates the blades in the container. The motor driver 112 operates the mixing motor 122 according to a speed of rotation set by the user. The type of the motor driver 112 depends on the type of the mixing motor 122. The back-EMF sensor 114 detects if the mixing motor 122 is facing resistance in rotation. The back-EMF is proportional to the speed of rotation of the mixing motor 122. The speed of the rotation of the mixing motor 122 is affected when the liquid artifact is too thick and hard to flow. The use interface 116 of the blending appliance includes a power switch, a regulator for the speed of the mixing motor 122, timer etc., that are present in a standard blender appliance.

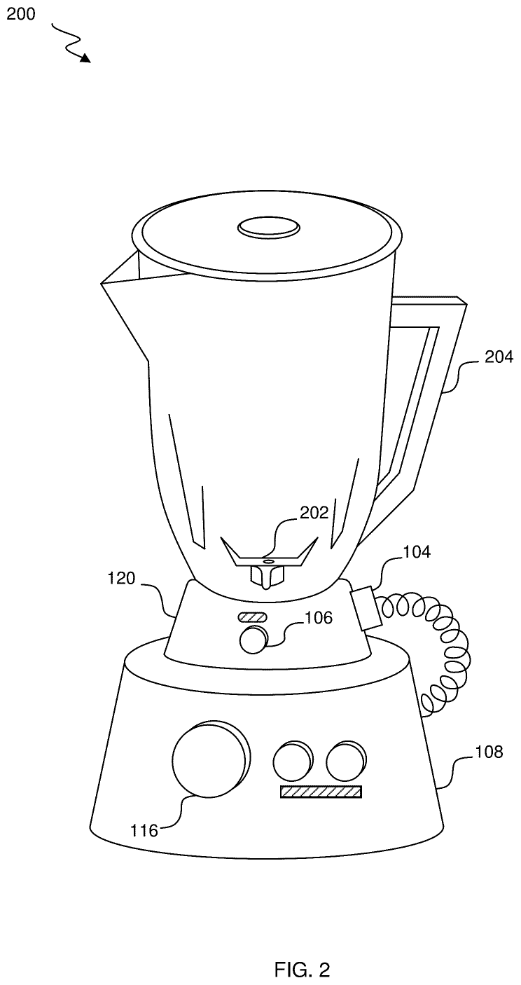

Referring to FIG. 2, illustrating a front profile of an embodiment of the blending appliance 200 with a power cord that uses a magnetic field to connect. The blending appliance 200 includes a blending container 204 resting on the collar 120. The blending appliance 200 is made of glass or any durable plastic to confine the liquid article. The blades 202 situated at the bottom of the blending container 204 are designed to chop food artifacts for their liquification. The blades 202 are either separable or a combined assembly depending on the design choices. The collar 120 is separable in some implementations, permitting easier cleaning of the blending appliance 200 and maintenance. When The blending appliance 200 is docked on the housing base 108 the shaft from the mixing motor 122 is attached to the blades 202 and rotates them. To reduce the effect of the vibrations on the person pouring the beverage, the handle is designed to be an anti-vibration handle by using, for example, shock-absorbing materials such as elastomers, gels, or the like.

In one embodiment, the power source 104 is a power cord that electrically connects the excitation transducer 102 to a main power source. The power cord enables the user to remove the blender container 204 from the housing base 108 and move it in a predefined radius. The radius depends upon the length of the cable of the power cord. The power cord is detachable permitting the blending container 204 to move freely once the user is done with the excitation transducer 102. The power cord uses magnetic coupling to remain connected to the blending container 204. The power cord includes a plug and a cable. The plug and the cable can be used as part of a power adapter for connecting the excitation transducer 102 to the power source in the housing base 108. The plug includes electrical pins, which are biased towards a corresponding various of contacts positioned on the cable. The plug and cable have a magnetic element. The magnetic element on one or both of the plug and cable can be a magnet, which is preferably a permanent rare earth magnet although electromagnets may also be used. A ferromagnetic element can be used for the magnetic element on the plug or cable that does not include a magnet. When the plug and cable are brought into proximity, the magnetic attraction between the magnet and its complement, another magnet or a ferromagnetic material, magnetically couples the plug and the cable and maintains the pins and contacts in an electrically conductive relationship. The magnetic connector allows the plug to break away from the cable if the plug or cable is moved with sufficient force, while still connected. In another embodiment, the power cord can be attached to the housing base 108 or the collar 120 with a power port. The power cord can have a retractable mechanism to recoil the cable of the power cord to make the handling of the blender appliance manageable.

In another embodiment, the power source 104 is a rechargeable battery or a capacitor. The capacitor can store a small amount of energy compared to the rechargeable battery but charge and discharge faster. The rechargeable battery is charged when the blending container 204 is docked in the housing base 108. The rechargeable battery can be charged with electromagnetic induction. A power transmitter can be set up at the housing base 108 and a power receiver on the bottom of the collar such that upon docking the blending container 204 the induction power flow from the housing base to the rechargeable battery. The rechargeable battery or the capacitor is designed to have enough energy storage capability to power the excitation transducer 102 for at least one use. The rechargeable battery is designed to be compact and fit in the collar seamlessly.

In another embodiment, the power source 104 is a magnetic power source that powers the excitation transducer 102 using the principles of electromagnetic induction. A primary coil is installed inside in the housing base 108 and a secondary coil is installed in the blending container 204. When the blending container 204 is docked on the housing base 108 the coils are coupled, and the energy transfer takes place. The electromagnetic induction is a method of transferring electrical energy without any direct electrical contact between a power receiver and a power transmitter. The power transmitter generates a high frequency alternating current (AC) in the primary coil. The AC current generates an electromagnetic flux around the primary coil, which induces a voltage in the secondary coil of the power receiver when tuned at a resonant frequency.

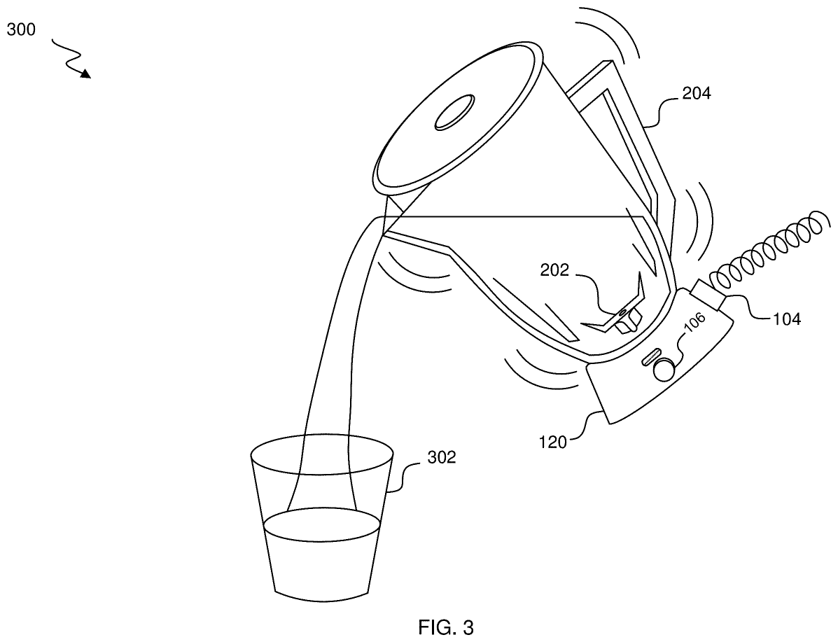

Referring to FIG. 3, illustrating a diagram of an embodiment of the blending appliance 200 vibrating during the pouring of liquid artifacts. The vibration from the excitation transducer 102 can be used in various instances, for example to enhance pourability of semi-fluid liquids. The exemplary embodiment shows the blender with the excitation transducer 102 turned on. The vibrations in the container improve the pourability of the fluid resulting in a smooth flow of fluid into a cup 302. The vibration produced by the excitation transducers dislodges the food articles from the inner surface of the blending container 204. The chunks of sticking and thick liquids are sometimes stuck in the crevices of the blending container 204 and are hard to reach. The vibrations liquify the semi-fluid masses and help them flow. The excitation transducer 102 can also be used while cleaning the blending container 204.

The excitation transducer 102 aids in blend performance, cleaning, and pourability. The users struggle with thick liquids in the blending container 204 that get stuck to the walls of the blending container 204 and cannot be poured easily out of the blending container 204. The users also struggle with inconsistencies during the blending process, such as when there is cavitation occurring and causing very poor mixing and turnover performance. In these scenarios, the user must shut the blender off, use a spatula or other tool to mix the blending liquid, and then restart the blending profile. The users have a difficult time cleaning blenders, especially underneath the blades and crevices of the blending container 204. The inclusion of the excitation transducer 102 permits the blender to have a cleaning cycle where it excites the blending container 204 and helps to remove debris and mold build up. The excitation transducer 102 is mounted securely to the blending container 204 to create a solid base for transmitting the vibrations through it. The vibrations will be transmitted through multiple paths in the blending container 204, including the walls of the blending container 204, blades 202, blender blade bushings and seals, and the blended liquid. This permits the blender to be cleaned using the excitation transducer 102 by transmitting the vibrations through areas that are difficult to clean and breaking up the debris and build-up.

In some embodiments, the blending appliance may be used to blend semi-fluids that are viscous and hard to flow or consists of solid food artifacts in abundance. The vibrations from the excitation transducer 102 induce liquefaction of the solid food artifacts. The liquefaction occurs when vibrations cause solid food particles in the liquid artifacts to lose contact with one another. The vibrations transfers from the body of the blending container 204 to the solid food particles proximate to the interior surfaces. The vibrations cause the liquid pressure to increase to the point where the solid food particles can readily move with respect to one another. As a result, the solid food particles behave like a liquid and become easy to flow in the liquid artifacts.

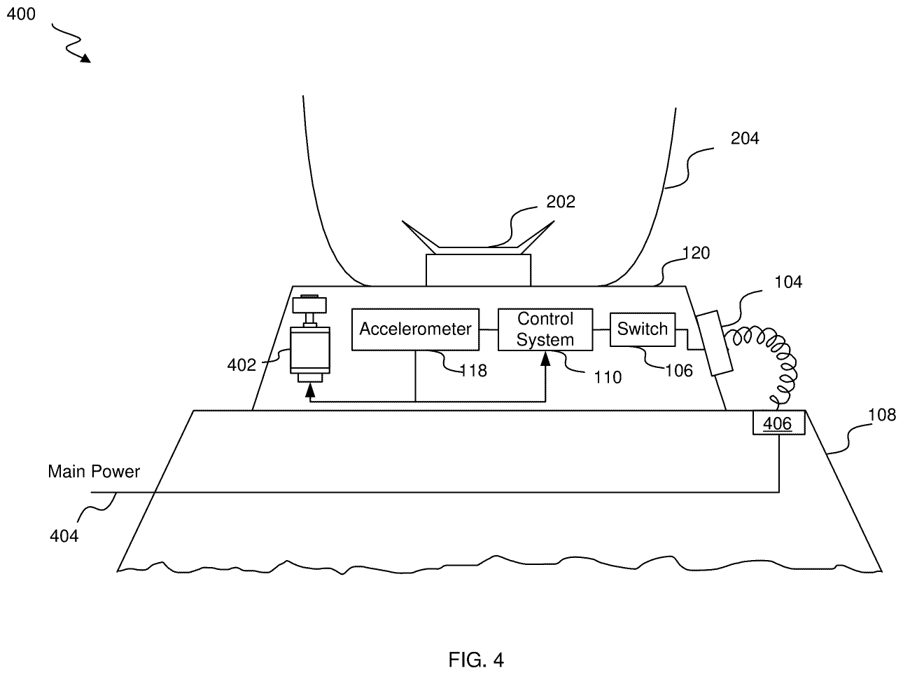

Referring to FIG. 4, illustrating a block diagram of an embodiment of the excitation transducer 102 that uses ERM motor 402 to create vibrations. The ERM motor 402 is one example of a vibrating motor. The ERM motor 402 includes the usual direct current (DC) motor components like a rotor, carbon brushes, stator, etc. with the addition of weights. The ERM motor 402 is designed with two sets of weights and mounted on the end of a motor's shaft. These weights become the “unbalanced” mass that is used to generate vibratory force as the vibrator rotates. To produce the vibration, the rotating mass must not be balanced. The two sets of weights on the industrial vibrator's shaft can be rotated relative to one another to produce a maximum unbalanced value resulting in the highest force output at a given rotation per minute (rpm). The weights can be adjusted so they oppose each other and become balanced. The balanced rotating mass produces no vibratory force.

Main power 404 is a form of electricity that is available in the household power outlets. The main power 404 provides typically a voltage of 110 or 230 volts and a frequency of 50 or 60 Hz, but could be inductive or DC in other embodiments. Although, the main power 404 is shown to be directly connected to the power source the blender appliance has current regulating circuitry designed in the housing base to meet specifications. For example, main power 404 can be converted with an AC/DC converter 406 in some embodiments.

In another embodiment, the excitation transducer 102 has a vibration regulator in addition to the switch 106. The user can control the frequency or amplitude of the vibrations through the vibration regulator. The vibration regulator controls the intensity of vibrations by adjusting the weights. The control system 110 can be used to determine a time and the magnitude of vibrations depending on the feedback from various sensors like the back EMF sensor 114, inclinometer, viscometer etc. The process of operating the excitation transducer 102 can be automated by using the back-EMF sensor 114 to determine if the blender is having trouble with blending the liquid. It can also be triggered by the user to improve the blend performance as they see fit. The accelerometer 118 is mounted on the ERM motor 402 to monitor the amplitude of vibration. The control system 110 can adjust the magnitude of vibration through the closed-loop control.

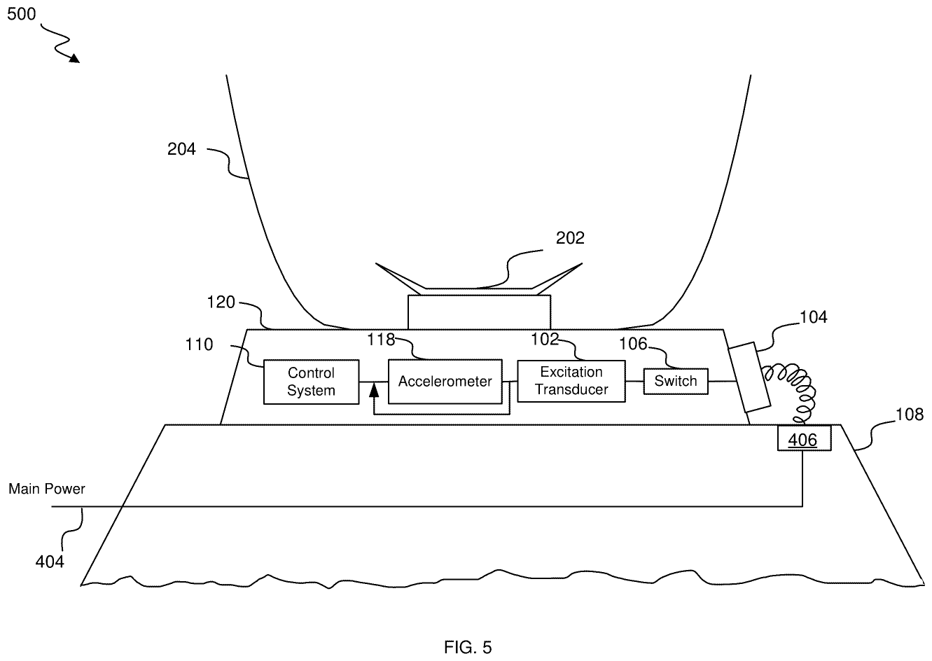

Referring to FIG. 5, illustrating a block diagram of an embodiment of an excitation device that uses the excitation transducer 102 to create vibrations. As previously discussed, the excitation transducer 102 is an electronic device capable of producing vibration like ultrasonic transducers, piezoelectric transducers, magnetostrictive transducers, etc. The ultrasonic transducers convert alternating current (AC) into ultrasound and vice versa. The ultrasonic transducers generate most vibrations on a resonant frequency. The transducers typically use piezoelectric transducers or capacitive transducers to generate or receive ultrasound. Piezoelectric crystals can change their sizes and shapes in response to voltage being applied. The capacitive transducers use electrostatic fields between a conductive diaphragm and a backing plate. The excitation transducer 102 is paired with the accelerometer 118 to create a closed-loop control system that will sweep through frequencies until the resonant frequency is found. The accelerometer 118 is mounted over the ultrasonic transducer and measures the response of the ultrasonic transducer over a wide range of frequencies. The frequency where the ultrasonic transducer produces the magnitude of vibrations that is desired, the control system 110 uses that excitation signal to operate the ultrasonic transducer.

In one embodiment, the accelerometer 118 is implemented using Micro-Electro-Mechanical Systems (MEMS). MEMS accelerometer 118 is fabricated using microelectronics manufacturing techniques. These techniques typically create microscopic-sized mechanosensing structures on silicon. When used in conjunction with microelectronic circuits, MEMS sensors can be used to measure physical parameters such as vibrations. MEMS accelerometer 118 takes significantly less power than the piezoelectric transducers and is quite compact.

The accelerometer 118 works on the principle of a mass on a spring, when the thing they are attached to accelerates then the mass wants to remain stationary due to its inertia, and therefore, the spring is stretched or compressed, creating a force that is detected and corresponds to the applied acceleration.

In one implementation, the accelerometer 118 can be used to monitor the inclination of the blending container 204. When the user inclines the blending container 204 to pour the fluid, the accelerometer 118 senses the movement and activates the excitation transducer 102. The accelerometer 118 can be calibrated to sense the forward incline only, as excitation device has no use during a backward incline. The user usually reduces the inclination of the blender to reduce the flow of the fluid, and producing vibrations at that motion hinders the desire of the user. The blender has the switch 106 in an accessible location to permit manual control as well as an auto option. The control system 110 can be programmed to enable a higher magnitude of vibrations with an increase in the inclination of the blending container 204.

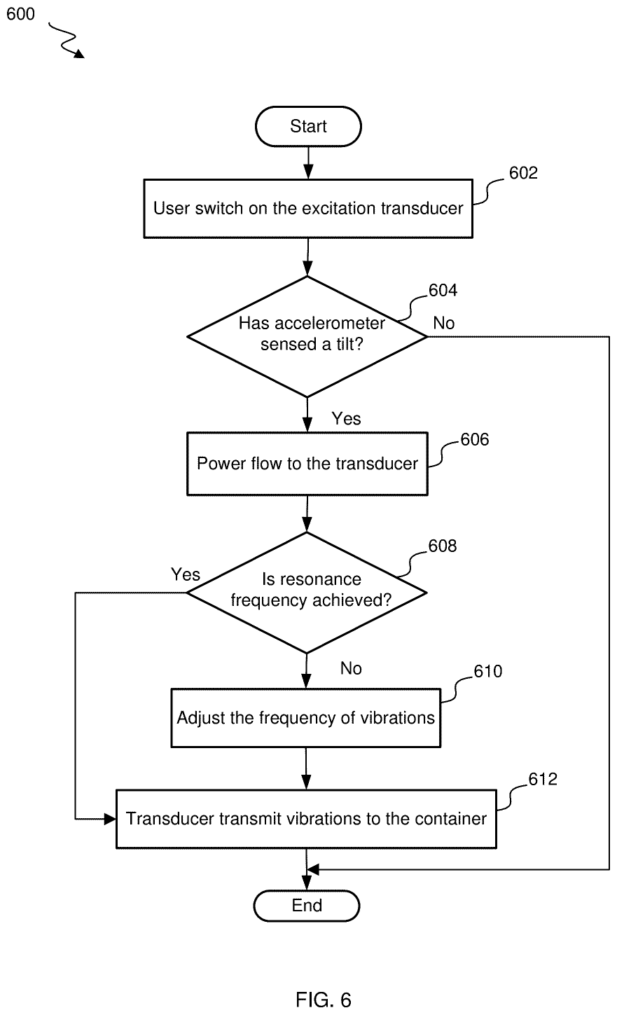

Referring to FIG. 6, illustrating a flowchart of a process of automatic activation of the excitation transducer 102 in response to the back EMF sensor. At block 602, the process begins with switching on the blending appliance 200. The blending appliance 200 can have wireless connectivity like WiFi, Zigbee™, Bluetooth™, cellular, or some other wireless protocol and can be switched on remotely. At block 604, the accelerometer 118 mounted on the blender to sense the incline of blending container. The incline of the blending container 204 signifies the user is trying to pour the fluid. When the accelerometer 118 senses the incline of the blending container 204, the excitation transducer 102 is turned on, at block 606. The accelerometer 108 is calibrated to differentiate between the forward incline and the backward incline. The excitation transducer 102 is only turned on during the forward incline.

At block 608, the control system 110 checks the response of the excitation transducer 108 at different frequencies and compares it against a desired response. The resonance frequency is the frequency at which the ultrasonic transducer produces intensified vibrations. If the resonance frequency is achieved, the control system 110 operates the excitation transducer 102 on the same excitation signal. If the resonance frequency is not achieved the frequencies are adjusted through a closed-loop control, at block 610. At block 612, the excitation transducer 102 transmits the vibrations to the blending container 204.

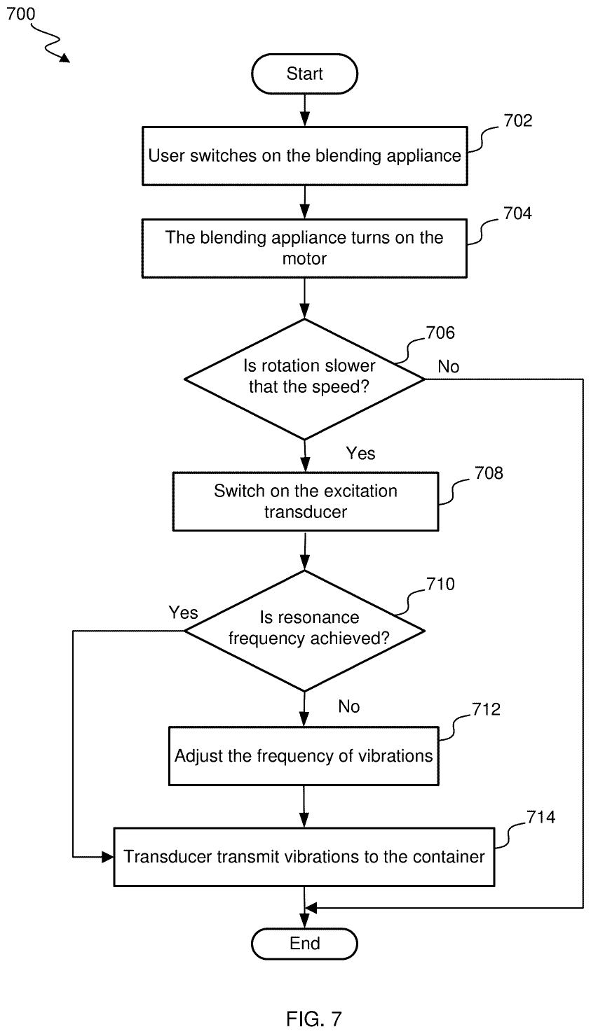

Referring to FIG. 7, illustrating a flowchart of a process of activation of the excitation transducer 102 in response to the back-EMF sensor 114. At block 702, the process begins with switching on the blending appliance 200. At block 704, The blending appliance 200 enters its normal operation mode. The normal operation of the blender is defined as driving the mixing motor 122 to rotate the blades 202 or stirrers in order to blend, chop or mix the artifact (i.e., fluid food items in the blending container 204).

At block 704, the control system 110 uses the back-EMF sensor 114 to check the performance of the mixing motor 122. The back-EMF sensor 114 can use phase voltage measurement where a voltage across one of the motor phases is not currently energized. This voltage represents the back-EMF of the mixing motor 122. A hall back sensor can be utilized to measure the magnetic field and hence the back-EMF. The back-EMF is proportional to a speed of rotation of the mixing motor 122. The control system 110 checks if the performance of mixing motor 122 is lagging, at block 706. According to the output of the back-EMF sensor 114, the control system 110 activates the excitation transducer 102 corresponding to the speed of the mixing motor 122, at block 708.

For instances, the user is making a smoothie. Initially, when the blender starts the operation the mixing motor 122 faces resistance due to a big chunk of fruit. The chunks that settle at the bottom act as immovable masses, deterring the blades 202. The back-EMF sensor 114 signals the speed of the mixing motor 122 to the control system 110. The control system 110 activates the excitation transducer 102. The vibrations shake the blending container 204 moving the fruits. The vibration creates additional momentum that facilitates the rotation and eases the load of the mixing motor 122. Once the mixing motor 122 is back on its designed speed the back-EMF sensor 114.

At block 710, the control system 110 checks the response of the excitation transducer 102 at different frequencies and compares it against a desired response. The resonance frequency is the frequency at which the ultrasonic transducer produces most vibrations. If the resonance frequency is achieved the control system 110 operates the excitation transducer 102 on the same excitation signal. If the resonance frequency is not achieved the frequencies are adjusted through a closed-loop control, at block 712. At block 714, the excitation transducer 102 transmits the vibrations to the blending container 204.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process that is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read-only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as a limitation on the scope of the disclosure.

We claim:

1. A blending appliance for blending liquid artifacts, the blending appliance comprises:
a housing base comprising a mixing motor to rotate a blade in contact with a liquid artifact during normal operation of the blending appliance; and
a blending container removably coupled with the housing base to couple the mixing motor to the blade, wherein the blending container comprises:
an excitation transducer to induce liquefaction through vibrations in the liquid artifacts proximate to interior surfaces of the blending container, and
a power source that powers the excitation transducer to agitate the liquid artifacts proximate to the interior surfaces of the blending container.

2. The method for the blending appliance for blending the liquid artifacts of claim 1, wherein the power source is a magnetic power source that electromagnetically transfers power from a coil in the housing base to the coil the blending container when the blending container is docked on the housing base.

3. The blending appliance for blending the liquid artifacts of claim 1, wherein power is contact coupled to the excitation transducer when the blending container is seated in the housing base.

4. The blending appliance for blending the liquid artifacts of claim 1, wherein power is coupled to the excitation transducer while the blending container is detached from the housing base.

5. The blending appliance for blending the liquid artifacts of claim 1, further comprising:
a back-electromotive force (EMF) sensor to monitor when a performance of the mixing motor is lagging while blending the liquid artifact.

6. The blending appliance for blending the liquid artifacts of claim 1, wherein the excitation transducer is coupled with an accelerometer to create a closed-loop control system for achieving a resonant frequency, wherein the resonant frequency intensifies a magnitude of the vibrations of the excitation transducer.

7. The blending appliance for blending the liquid artifacts of claim 1, wherein an accelerometer is coupled to the blending container to monitor a forward incline of the blending container, and wherein the excitation transducer is turned on in response to the forward incline.

8. A method for a blending appliance for blending liquid artifacts, the method comprises:
driving a mixing motor to rotate a blade in contact with a liquid artifact during normal operation of the blending appliance;
powering an excitation transducer coupled to a blending container by a power source, wherein the blending container is removably coupled with a housing base of the blending appliance; and
inducing liquefaction in the liquid artifact proximate to interior surfaces of the blending container while the blending container is detached from the housing base.

9. The method for the blending appliance for blending the liquid artifacts of claim 8,
wherein the power source is a magnetic power source that electromagnetically transfers power from coils in the housing base to the coils the blending container when the blending container is docked on the housing base.

10. The method for the blending appliance for blending the liquid artifacts of claim 8, further comprises:
a back-electromotive force (EMF) sensor to monitor when a performance of the mixing motor is lagging while blending the liquid artifact.

11. The method for the blending appliance for blending the liquid artifacts of claim 8, wherein the excitation transducer is coupled with an accelerometer to create a closed-loop control system for achieving a resonant frequency, wherein the resonant frequency intensifies a magnitude of the vibrations of the excitation transducer.

12. The method for the blending appliance for blending the liquid artifacts of claim 8, wherein an accelerometer is coupled to the blending container to monitor a forward incline of the blending container, and wherein the excitation transducer is turned on in response to the forward incline.

13. A blending appliance for blending liquid artifacts, the blending appliance comprises:
a housing base comprising a mixing motor to rotate a blade in contact with a liquid artifact during normal operation of the blending appliance; and
a blending container removably coupled with the housing base to couple the mixing motor to the blade, wherein the blending container comprises:
an excitation transducer to induce liquefaction in the liquid artifacts proximate to interior surfaces of the blending container, and
a magnetic power source that electromagnetically transfers power from a coil in the housing base to the coil the blending container when the blending container is docked on the housing base.

14. The blending appliance for blending the liquid artifacts of claim 13, further comprises:
a back-electromotive force (EMF) sensor to monitor when a performance of the mixing motor is lagging while blending the liquid artifact.

15. The blending appliance for blending the liquid artifacts of claim 13, wherein the excitation transducer is coupled with an accelerometer to create a closed-loop control system for achieving a resonant frequency, wherein the resonant frequency intensifies a magnitude of the vibrations of the excitation transducer.

16. The blending appliance for blending the liquid artifacts of claim 13, wherein an accelerometer is coupled to the blending container to monitor a forward incline of the blending container, and wherein the excitation transducer is turned on in response to the forward incline.
